(19) United States
(12) Patent Application Publication
(10) Pub. No.: US 2026/0320025 A1
(43) Pub. Date: Oct. 15, 2026

(54) A SYSTEM AND METHOD FOR IMPLEMENTING RESPONSIVE, COST-EFFECTIVE IMMUTABILITY AND DATA INTEGRITY VALIDATION IN CLOUD AND DISTRIBUTED STORAGE SYSTEMS USING DISTRIBUTED LEDGER AND SMART CONTRACT TECHNOLOGY

(71) Applicant: NANSEN PTY LTD, Kingston (AU)

(72) Inventors: Andrew David Collins, Chapman (AU); Rosemary Louise MacDonald, Googong (AU); Jacob Jarick, Thornlie (AU)

(73) Assignee: NANSEN PTY LTD, Kingston (AU)

(21) Appl. No.: 18/992,047

(22) PCT Filed: Jul. 4, 2023
(86) PCT No.: PCT/AU2023/050616

§ 371 Date: Jan. 7, 2025

(30) Foreign Application Priority Data
Jul. 18, 2022 (AU) 2022902008

(51) Int. Cl. G06F 16/23; G06F 16/27

(52) U.S. Cl. CPC G06F 16/2365; G06F 16/273; G06F 16/275

(57) ABSTRACT

A system for data storage in cloud systems by bringing cloud storage and blockchain technologies together into a single, secure and seamless service using governing smart contracts and application programming interface API integration, wherein the API provides a mechanism for a data owner to interact with one or a plurality of cloud-based storage platforms and one or a plurality of blockchain platform accounts in a manner that provides the cloud/distributed storage with the immutability of blockchain storage.

### FIELD OF THE INVENTION

In computing systems, both on cloud, on-premises, network edge, distributed and Internet of Things (IoT) devices and systems, storage of data is critical to the correct functioning of the system. This is typically true regardless of the system's role, industry, or function.

The secure storage of data on these systems has been a constant challenge for the computing industry with cyber security attacks increasing in sophistication despite the security controls of systems having improved. Even with decades of improvement to cyber security systems, media stories of corporate and government computer system compromises, data loss, data theft and misuse are common the world over.

The advent of distributed and cloud computing and data storage has both exacerbated the problem of securing data whilst also providing some improvement in security controls. Modern computing is characterized by the rapid and simple deployment of potentially complex computing systems accessed via a simple web or application interface. This ease of access and use broadens the risk profile of the system, insofar as a cyber attacker can take advantage of a misconfiguration or system vulnerability from the ‘outside’, or a malicious or disgruntled employee with system administrator rights can easily modify or delete any cloud storage repository, tenancy or file within. This may include for example, system log files and other critical data.

The present invention is aimed at solving the risk of accidental or deliberate deletion or modification of critical data by leveraging distributed ledger technology, Application Program Interface and smart contract technologies, combined with cloud computing and cloud storage to provide a means for protecting, sharing, archiving, and ensuring the immutability and integrity of critical data, regardless of its format, use, or how it was generated. Additionally, the present invention is aimed at overcoming the cost prohibitive issues arising from attempts to store data directly on a blockchain.

The present invention is also aimed at overcoming issues of slow transaction speeds without compromising distributed ledger security protocols.

### BACKGROUND

Prior art in this area has generally focused on three approaches to addressing these well-known issues of performance and cost of storage. Although prior art exists for combining features of blockchain and cloud technology and for immutable metadata storage in the blockchain, there is no disclosure in the prior art that defines integrating blockchain and cloud storage technology in a way that implements immutable storage within cloud or distributed storage systems.

The first approach seen in the prior art being the data owner storing files in their own storage repository, with the file integrity metadata of the stored file written to a blockchain or via a smart contract. This approach is discussed by TAPAS et al in “Toward Trustless Internet of Things: a Blockchain-based approach”, Università degli Studi di Messina, January 2021 and by RENNER et al. in “Endolith: A blockchain-based framework to enhance data retention in cloud storages”, 2018 26th Euromicro International Conference on Parallel, Distributed and Network-Based Processing (PDP). The second approach seen in prior art is to modify a blockchain node to include direct or distributed storage and the third involves direct storage of data or metadata on the blockchain in its present architecture which is disclosed in US 2019/0356493.

Other implementations of blockchain and cloud technologies have focused on using the blockchain as an immutable event log storage system as disclosed in US 2019/0102423, as a means to control cloud tenancies as disclosed in US 2018/02855939 or as a means to provide a unified user experience whilst using a plurality of disparate cloud storage services as disclosed in US 1021/0073177.

In respect to the above prior art, the cost and speed of blockchain based transactions is a significant impediment to the use of blockchain technology at scale and this issue is not resolved by any of the prior art, herein referred to as ‘Blockchain Caching’ or the ‘Blockchain Cache’. Currently it is prohibitively expensive to directly store even modest volumes of data on the blockchain due to the design and operation of the technology.

Several attempts have been made by prior art technologies to address these limitations of storage, cost, and speed. These attempts have centred around three main methods which have their own disadvantages. They are:
1. Direct storage on the blockchain. This method is cost prohibitive for any modest to large dataset. Consequently, it would not be commercially viable to adopt this method for the storage of large amounts of data or information.
2. Modification of blockchain node designs to include local, distributed or cloud storage. This approach has been implemented in the cryptocurrency ‘siacoin’, but requires the cooperation of current blockchain technology providers or a new blockchain service and has significant performance limitations. To date there has been no indication of any wide scale acceptance of this approach in practice. The ‘siacoin’ implementation also uses the blockchain as a method of tracking files stored in distributed file stores rather than as an immutable data storage system making it distinct from this invention.
3. Linking file metadata such as a file hash, typically via a smart contract, to a file stored in the user's cloud storage account. This has limited applicability, while file metadata may be stored on the blockchain to provide tamper detection, a malicious actor or other body with access to the user's storage account can easily modify or delete the file. This approach does not fundamentally change the security properties of existing solutions. Therefore, this approach has the disadvantage of removing a key attribute of blockchain technology, namely the immutable storage of files.

Additionally, transaction speeds, the time it takes to write data submitted from an application or user to the blockchain is both highly variable and prohibitively slow as compared to current cloud storage technologies. Due to these limitations in current blockchain technology, acceptance of that technology outside of the crypto-currency market and Distributed Finance (Defi) space has been limited to date. This is also a common limitation of solutions presented in the prior art.

The present invention provides a novel approach to enhancing cloud computing storage and allowing the storage of data immutably and addresses the disadvantages of prior art methods and the cost/speed of blockchain technology usage.

One specific example of the implementation is with the storage of security log files in cloud computing systems and platforms. Most computing systems generate log files, or records of events and actions that the system has taken in the process of performing its functions. These log files form a record, based in time, of the events in the system and can range in detail from only capturing major events to capturing every event that occurs. Log files are appended to as events occur and as such provide an invaluable record of what is occurring in the computer system and a historical record of what has happened in the event of a serious incident or security breach.

These log files serve many purposes, from helping system administrators diagnose issues on the computer or their application to understanding what occurred, and how it occurred, following a security incident or compromise. Without accurate and complete log files, system administrators are extremely disadvantaged, and unlikely to be able to identify what issues are occurring, when they occurred, how they occurred or what data was lost, transferred or manipulated.

Evidencing this, it is a well-known strategy for a cyber attacker to seek out and modify or delete log files as one of the first tasks they undertake after successfully compromising or gaining access to a computer system. By modifying the logs to remove any record of their activity or deleting the logs altogether, the attackers make it much more difficult for a system administrator to identify that a security compromise has occurred, what the scope of the attack was, if the attacker is still active in the system, what applications they installed, what data was modified or lost and how they compromised the system to gain access. Answering these questions is critical to any successful recovery effort.

Currently no secure storage mechanism or the prior art can provide immutable file storage without significant performance and cost implications. The presented invention solves this problem and brings large scale, low-cost immutable data storage at the performance levels demanded by modern IT systems.

The present invention aims to solve the above discussed drawbacks of the prior art technology in secure data storage by using a novel combination and approach of API services, smart contract and blockchain technology and dedicated cloud/distributed storage tenancies to immutably store data in a cost-effective manner.

Additionally, a novel blockchain caching system is disclosed that significantly increases effective blockchain write speeds. The novel process and approach of the present invention in combination with the novel blockchain caching technology of the present invention provides a significant performance and cost improvement over existing approaches and prior art.

The technology of the present invention, in one iteration, has the added advantage of applying in such a way that enables users to choose their preferred cloud storage service and the preferred blockchain. Due to this flexibility, the method of the present invention is vendor agnostic and is applicable to cloud storage and distributed file storage solutions.

### SUMMARY OF THE INVENTION

The present invention essentially relates to a system for implementing cost-effective immutability and data validation within cloud/distributed storage systems using a novel configuration of distributed ledger, cloud storage and smart contract technology. The invention solves the issues of cost of storage and transaction speeds in a unique and novel way by bringing cloud storage and blockchain technologies together into a single, secure, and seamless service.

In one embodiment of the present invention, one or a plurality of Application Programming Interfaces (API) works in an asynchronous manner with one or a plurality of master smart contract services to provide the interface(s) between one or more user selected blockchain(s) and one or more user selected cloud storage system(s).

The API logical unit manages one or more file storage systems and works in parallel, asynchronously with a smart contract system which manages file metadata storage, file protection rules, sharing rules, file metadata management and aspects of storage cost management across one or a plurality of blockchain solutions. This allows the system to store encrypted data in the cloud and the relevant encrypted metadata in the blockchain, successfully implementing blockchain file immutability in cloud storage solutions. Additionally, the use of asynchronous communication between the smart contract(s) and API service in combination with blockchain request storage results in effective decoupling of transactions.

The present invention uses existing technologies and some well-known methodologies into a unique architecture that is novel compared to the prior art.

A key advantage of the present invention is that users are not required to manage blockchain nodes, wallets, or smart contracts to implement immutable data storage and one iteration ensures the user is the only one who can decrypt their data by using user mode encryption.

According to this invention, file data stored is encrypted using user selected keys and file meta-data is encrypted using rolling keys. In one embodiment of the present invention, users are responsible for managing their keys and keys are not stored by the system. This results in each user being in control of their data without the need to trust any 3^{rd} party.

In one embodiment of the present invention, one or a plurality of API's working in parallel but asynchronously with one or a plurality of Smart contract interfaces (API/Smart Contract) provides a mechanism for a data owner, website, application, or computer service (hence forth referred to as the data owner) to interact with, store data in, retrieve, share and other functions of a smart contract or immutable application code associated with an individual blockchain implementation and any storage medium or blockchain cache managed by the embodiment.

The smart contract or immutable program code also controls one or a plurality of blockchain platform accounts via dedicated smart contract code per blockchain, allowing file meta data to be written to one or more blockchains. The API service controls one or a plurality of cloud or internet addressable storage solutions including but not limited to cloud and distributed storage systems.

The use of a smart contract stored on the blockchain to provide file security and immutability services ensures that the interface and any functions provided by it are transparent and immutable to the data owner. The API/smart contract is able to perform a range of programmed functions that includes, but is not limited to, access token passing and management, data encoding, data unencoding, data encryption, data decryption, data storage, data retrieval, file sharing, metadata read/write, metadata lookup and searching.

In addition, the smart contract works in parallel, asynchronously with the API of the present invention is able to enact functions to engage services within one or more blockchain storage services. These services include but are not limited to serverless functions performing data processing roles, authentication or caching of storage requests.

A unique aspect of the smart contract/API system used in the present invention is its ability to enact functions to engage services within one or more blockchain implementations or services and one or more cloud or distributed storage services. This includes private, public and hybrid blockchain operating models. One or more blockchain services may be used, as defined by input to the user API, for the storage of file metadata into one or more blockchain services The choice of blockchain service is selectable via the user API.

According to another aspect of the present invention, data is encrypted in the smart contract based on symmetric encryption keys generated by the TXProc function. Another embodiment may use encryption keys supplied by the user for meta data encryption. The encryption key is not stored, cached or in any way retained post encryption of the file. Files are stored in one or more cloud storage systems by the API/smart contract which has read-write control over each dedicated cloud or private storage tenancy.

In another aspect of the present invention, asymmetric encryption and the keys may be or may not be stored by the system directly.

According to the present invention, when data is written to cloud storage, a set of unique metadata is generated for each file stored. This metadata includes, but is not limited to, a hash of the encrypted file, internet location and retention period. This metadata is written to one or a plurality of public, private and/or hybrid blockchain implementations which are specified by the data owner at the time the file is written. Where more than one cloud storage location is selected by the data owner, a unique internet location (FileGUID) is created for every copy of the file. The FileGUID is used as the reference to couple blockchain and storage records to their corresponding pairing and is unique for every file stored, including file duplicates.

According to another aspect of the present invention, data owners can use the API/Smart Contract interface to interact with one or more cloud storage systems to provide search services such as, but not limited to, retrieval of file lists, retrieval of file properties, retrieval of file metadata, statistics on the data owners'files and other functions.

The present invention provides data owners as having permission to access one or more files, to use the API provided by the smart contract/API system to interact with one or more cloud storage systems to retrieve files from one or more cloud storage systems. These files are validated by the smart contract using file metadata information stored in one or more public, private and/or hybrid blockchain services. Retrieved files are decrypted by the data owner or those the data owner has given permission to access one or more files, using a secret key provided by the user.

In accordance with one implementation of the present innovation, data owners may share one or more files with one or more external parties. In one potential iteration of the invention, the external parties do not need an account or any form of identification in the system. To share a file the data owner will specify a shared secret key that will be used to encrypt the shared file as a dedicated copy. The file will be separately encrypted and stored within a designated area of the system, logically representing a second encrypted file with a new secret key. The external parties or the data owner will then be provided a link to the new file that is internet addressable without authentication.

In another aspect of one interaction of the present invention, data owners may select a range of sharing parameters that define the circumstances where and when the file can be shared. For example, and not limiting the scope of this embodiment, the data owner would be able to define how many times the shared file is accessed before access is revoked or is able to define a sharing time-period, where after the period has expired, access is revoked. The sharing of files is managed by the smart contract/API and sharing parameters may or may not be written to one or more blockchains, depending on the embodiment of the innovation.

According to one interaction of the present invention, data owners are able to store files with a defined retention period. The retention period is granular down to hours and realistically infinite in possible timescales. Data is stored as per the process above for all files, but additional metadata on file retention is written by the smart contract to one or more public and/or private blockchain services. A function, either serverless or server based, operates on the API for each supported cloud service or via a centralized service, to delete the file from one or more cloud storage services once the data owners specified retention period has passed.

According to the present invention, data owners can define the jurisdiction where their data is stored, notwithstanding the distributed nature of some supported storage mediums. To illustrate, the data owner may prefer their data stored within the Asia Pacific region, and as such the data will be distributed amongst storage nodes in that region exclusively. Additionally, the user may select a globally distributed file system where the file is distributed according to the file systems rules.

### DETAILED DESCRIPTION OF THE INVENTION

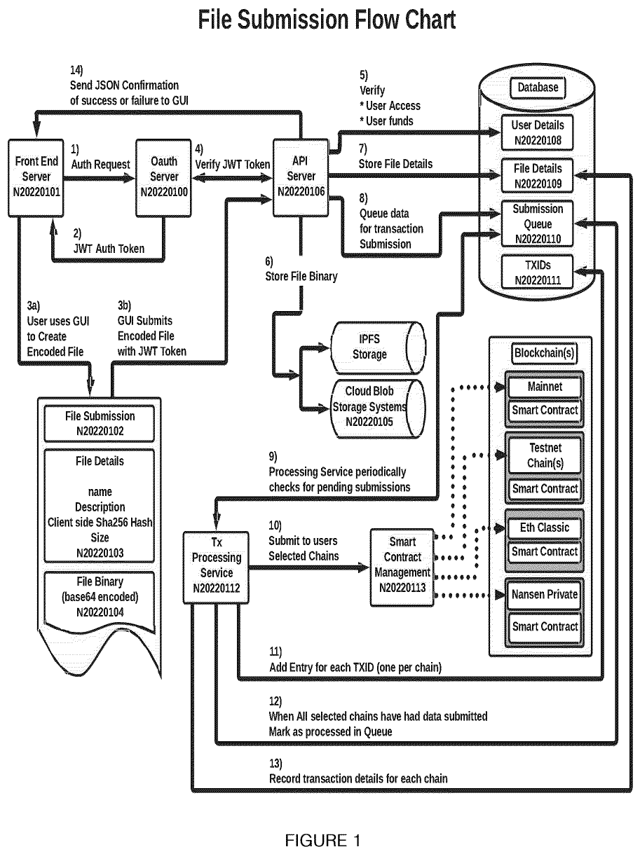

FIG. 1 is a schematic representation of a preferred embodiment of the present invention. The keys steps of this embodiment are described below with reference to FIG. 1.

In step 1 of this embodiment, the front-end server (N20220101) manages web page requests made from users. In the example shown, the front-end server requests an authentication server (N2022100) for data that is hosted by another service where the user's identity is already known. In other words, the authentication of the user's identity is managed by using another service which has already verified who the user is. This method is generally called open authentication (Oauth). Although this is the authentication used in this implementation of the invention, the invention may use any applicable authentication model.

The step 2 of the embodiment is the JSON Web Token (JWT). A JWT is an open standard (RFC 7519) that defines a self-contained way for securely transmitting information between parties as a JavaScript Object Notation (JSON) object. By signing the data, the authenticity of the token arising from the individual can be verified and through encryption, the data is protected from being read by persons who are not authorised to read it. In the present invention, JWT's are used as part of the identity authentication process. In this process, steps 1 and 2, the front-end server requests a JWT from the Oauth server(s). On receipt of such a request, the Oauth Server/s returns the requested JWT token for the supplied user login information or an error code for invalid users.

The step 3 of this embodiment involves submission of a file (N2020102). Once a JWT token is issued, the user may submit a file which may be a document, image, video or other digital data storage format. In the first step of the file handling process, the file details are recorded which include the name of the file and a user supplied description of the file (N2020103). The file is then hashed for integrity and verification purposes. It should be noted that the purpose of the hash is to provide a means to ensure that the file originally submitted remains in its original state and it has not been modified in any way. The file is encrypted then encoded as base64. The binary file (N2020104) is then passed to the API server (see FIG. 1) that manages multiple functions.

In the step 4 of the process, the API verifies the JWT token with the Oauth server, which means it verifies that the token issued for the user to allow them to perform the action (submitting a file) is the same token associated with the action performed.

In step 5, once the JWT token is verified, the user details and record keeping are stored in the blockchain cache and at this time, in step 6, the encrypted and encoded file is stored in one or more blob stores (N2020105) or distributed file systems with a global Unique Identifier (GUID) set as the filename. The blob store and its geographic location are selected by the user.

In step 8, these file details are passed to the novel blockchain cache via, the Tx Queue (step 8). The Tx Queue is the mechanism by which data is managed between the API server (N2020106), the Blockchain Cache (N2020107) and one or more blockchain services.

It should be noted that there are no limitations to the user's choice of blockchains, a few examples are represented for illustration purposes only. The data is assigned a TXID (which provides a unique identifier) so that the order in which the data should be processed or managed is determined.

In step 9 the Tx Processing Service (N2020112) checks the Submissions Queue table for pending submissions/transactions. It should be noted that the transaction queue service allows the API to offload blockchain submissions to the blockchain cache for blockchains which have excessive block write times.

In step 10, the queued submission data is then submitted to the user's (clients) selected chains via a Smart Contract Management server (N2020113) which comprises a Smart Contract and integration systems.

In step 11, records the TXID for each user blockchain selected to the file table within the blockchain cache to allow expediated file searching.

Step 12 involves marking the queued data item ‘processed’ once data is submitted to the relevant blockchain(s) and a block write event containing the data is confirmed for each chain.

In the final step, step 13, file meta data is stored for each file stored on each blockchain selected by the user for that file.

It should be noted that the TXIDs can be retrieved by querying the file GUID via the API which serves as proof of the data being stored. However, a preferred method to verify the data is to use a Distributed App (DApp) and access the file meta data using the chain ID, smart contract address, and the contract Index.

It should be noted that, although caching and asynchronous communications are well known techniques, their application to blockchain technology is unique and when combined with the above smart contract and API based integrations to form a cohesive service, represents a new and novel blockchain technology.

In this embodiment, file data and file meta data is encrypted.

In this embodiment of the present invention, the associated smart contracts (one per chain) control all transactions executed on the chains they are associated with. Specifically, the smart contract enables the storage of any binary data or file meta data to any blockchain.

In this embodiment of the invention, files are stored in java script object notation (json) in a compressed and encrypted format. Once a file is stored, the smart contract then returns the storage index information to the Blockchain cache. For each individual chain the Blockchain cache records the following information in json (see FIG. 1, 13):
result[“Name”]=DbFile.Name;
result[“Description”]=DbFile.Description;
result[“Sha256”]=DbFile.Sha256Hash;
result[“Size”]=DbFile.SizeBytes.ToString( );
result[“Guid”]=DbFile.FileGuid.ToString( );
result[“StoreForDays”]=DbFile.StoreForDays.ToString( );
result[“StorageCountryCode”]=DbFile.CountryCode;
result[“StorageMethod”]=DbFile.StorageMethod;

This information allows users to access file metadata independently of the API. For example, users can access this information through a Distributed Application (DApp).

While various embodiments of the present invention have been described above, it should be understood that they have been presented by way of example only, and not by way of limitation. It will be apparent to a person skilled in the relevant art that various changes in form and details can be made therein to suit different situations without departing from the spirit and scope of the present invention. Thus, the present invention should not be limited by any of the above-described exemplary embodiments.

1. A system for data storage in cloud systems by bringing cloud storage and blockchain technologies together into a single, secure and seamless service using one or a plurality of governing smart contracts and application programming interface API integration, wherein the API provides a mechanism for a data owner to interact with one or a plurality of cloud-based storage platforms and one or a plurality of blockchain platform accounts in a manner that provides immutable large scale cloud storage, file history and integrity information.

2. A system as defined in claim 1 where in the API/smart contract system performs a range of programmed functions that includes, but is not limited to, user authentication, access token passing and management, data encoding, data unencoding, data encryption, data decryption, data storage, data retrieval, file sharing, metadata lookup and searching whilst operating asynchronously with a master smart contract to provide the interface between one or more user selected blockchain(s) and one or more user selected cloud storage system(s) where the cloud storage is controlled programmatically by the API/Smart contract and is outside the control of the user directly.

3. A system as defined in claim 2, wherein the API working in parallel, asynchronously with one or more smart contract system(s) which manages file meta data storage, file protection rules, sharing rules and aspects of storage cost management across one or more blockchain solutions for allowing the system to store data in one or more cloud storage tenancies managed by the system, and storing the relevant metadata and access rules in the blockchain, and implementing blockchain file immutability in cloud storage solutions.

4. A system as defined in claim 3 wherein a DApp engages synchronously or asynchronously with the smart contract and the API functions to engage services within one or more cloud or distributed file storage services that include serverless functions performing data processing roles, authentication or caching of storage requests and one or more smart contracts to engage services within one or more blockchain implementations for the storage of file metadata into one or more blockchain services using a smart contract for each chain.

5. A system as defined claim 4 wherein the files are stored in one or more cloud storage systems by the smart contract/API service which has exclusive read-write control over each dedicated cloud, distributed or private storage tenancy and where the non-exclusive blockchain services includes private, public and hybrid blockchain operating models and the choice of blockchain is selectable via the public API.

6. A system as defined in claim 5 wherein when data is written to cloud storage, a set of unique metadata that includes a hash of the encrypted file, unique file identifiers, geographic storage location and retention period is generated for each file is written to one or a plurality of public private, and/or hybrid blockchain implementations and one or a plurality of pre-defined cloud storage tenancies which are specified by the data owner at the time the file is written.

7. A system as defined in claim 6 that uses one or a plurality of API interfaces provided by one or a plurality of smart contracts that provides file management, encryption, metadata generation and storage, search, and other file management functions, with the smart contract ensuring any file management, access rules and other critical access information is written to one or a plurality of blockchains wherein for file sharing functions, the smart contract will use the user supplied encryption key to create a new copy of the file and encrypt the file with a new key, generating and storing the appropriate metadata and access rules on the blockchain and cloud storage.

8. A system as defined in claim 7 that uses asynchronous communications to improve blockchain write performance by:
Passing on the file details to a database via a TxQueue which is a mechanism by which data is managed between the API server, the caches and user's choice of blockchains;
Checking the Submissions Queue table for pending submissions/transactions via a Tx processing service check;
Submission of the queued information to the user's (clients) selected chain/s;
Recording the TXID for each user chain selected to the file database table; and
Marking the queued data item as processed once data is submitted.

9. A system as defined in claim 8 wherein data owners and those identified by the data owner as having permission to access one or more files is able to use the API provided by the smart contract/API system to interact with one or more cloud, distributed or private storage systems to retrieve files from one or more cloud storage systems in which the files are validated using file metadata information stored in one or more public, private and/or hybrid blockchain services by the smart contract wherein said metadata includes parameters such as who the file is shared with, for how long and how many times it can be accessed before access is revoked.

10. A system as defined in claim 9 wherein data owners are able to store files with a defined retention period in which the retention period is granular down to seconds and practically infinite in possible timescales where the storage duration is written to one or a plurality of blockchains as a component of the files integrity metadata and updated based on user requests via the API.

11. A method for data storage in cloud systems by bringing cloud storage and blockchain technologies together into a single, secure and seamless service using a governing smart contract and API logic code using a system as defined in claim 1 that effectively implements file immutability in cloud storage solutions, the said method comprising the steps of:
A front-end server managing web page requests made from users and feeding data to an Application Program Interface (API);
Securely transmitting information between parties via a Jason Web Token (JWT) as a JavaScript Object Notation (JSON) object signing the data;
Verifying the authenticity of the token arising from the transaction through encryption and using JWT's as part of the identity authentication process to securely transferring data between parties or the servers;
Submission of a file once a JWT token is issued, recording file details and hashing for integrity and verification purposes to ensure that the file originally submitted remains in its original state and it has not been modified in any way;
Encoding the file, regardless of content or formatting, as base64 and converting it to a binary file for storage and passing the binary file to the API server;
Verification JWT token by the API with Oauth server to ensure that the token issued for the user that allows them to perform the action (submitting a file) is the same token associated with the action performed (submitting a file);
Storing the user details in the blockchain cache service once the JWT token is verified with a global Unique identifier (GUID) set as the filename for each instance, by the smart contract;
Passing on the file details to the database via a Tx Queue which is a mechanism by which data is managed between the API server, the caches and user's choice of blockchains;
Checking the Submissions Queue table for pending submissions/transactions via a Tx processing service check;
Submission of the queued to the user's (clients) selected chain/s;
Recording the TXID for each user chain selected to the file database table;
Marking the queued data item as processed once data is submitted; and
Storing file meta data on chain(s) using a smart contract for each chain.

12. A system for data storage in cloud systems by bringing cloud storage and blockchain technologies together into a single, secure and seamless service using a governing smart contract and API logic code using a system as defined in claim 1 that effectively implements file immutability in cloud storage solutions, the said system further comprising:
A front-end server managing web page requests made from users and feeding data to an Application Program Interface (API);
A means for Securely transmitting information between parties via a Jason Web Token (JWT) as a JavaScript Object Notation (JSON) object signing the data;
A means for verifying the authenticity of the token arising from the transaction through encryption and using JWT's as part of the identity authentication process to securely transferring data between parties or the servers;
A means for submitting of a file once a JWT token is issued, recording file details and hashing for integrity and verification purposes to ensure that the file originally submitted remains in its original state and it has not been modified in any way;
A means for encoding the text file as base64 and converting it to a binary file for storage and passing the binary file to the API server;
A means for verifying JWT token by the API with Oauth server to ensure that the token issued for the user that allows them to perform the action (submitting a file) is the same token associated with the action performed (submitting a file);
A means for storing the user details in the blockchain cache service once the JWT token is verified as a binary or raw file stored in one or a plurality of cloud blob store(s), private storage or distributed storage with a global Unique identifier (GUID) set as the filename for each instance;
A means for passing on the file details to the database via a Tx Queue which is a mechanism by which data is managed between the API server, the caches and user's choice of blockchains;
A means for checking the Submissions Queue table for pending submissions/transactions via a Tx processing service check;
a means for Submission of the queued to the user's (clients) selected chain/s;
a means for recording the TXID for each user chain selected to the file database table;
a means for marking the queued data item as processed once data is submitted; and
a means for storing file meta data on chain(s) using a smart contract for each chain.
